(19) United States
(12) Patent Application Publication
(10) Pub. No.: US 2025/0354619 A1
(43) Pub. Date: Nov. 20, 2025

(54) INCREASED FLOW BACK PRESSURE REGULATOR

(71) Applicant: DDS INVESTMENTS, LLC, Junction City, KS (US)

(72) Inventor: Bryce W. Burris, Manhattan, KS (US)

(73) Assignee: DDS INVESTMENTS, LLC, Junction City, KS (US)

(21) Appl. No.: 18/663,938

(22) Filed: May 14, 2024

(51) Int. Cl. F16K 17/04; F16K 27/02

(52) U.S. Cl. CPC F16K 17/0406; F16K 27/0245

(57) ABSTRACT

A back pressure regulator has an expanding nipple. A fluid passageway has a first inner diameter and a second inner diameter larger than the first inner diameter. The expanding nipple has an inlet connecting thread at a flow inlet for connecting to an inlet pipe and a second threaded end for connecting to a larger pipe. A reducing has a flow outlet with an outlet connecting thread to threadedly connect to an outlet pipe of the same size as the inlet pipe. A flow restrictor assembly is disposed in the reducing tee to restrict flow therethrough.

### FIELD

The present disclosure generally relates to back pressure regulators used in the oil and gas industry, and more specifically to a back pressure regulator that reduces the flow velocity of fluid entering the back pressure valve, which reduces erosive effects on the internal components of the back pressure regulator.

### BACKGROUND

Crude oil processing systems typically have pressure regulators in place that maintain or control the pressure of a process fluid within the system. Maintaining and controlling the pressure of the fluid within the system ensures that pressure sensitive instruments are protected, and that the system remains balanced throughout the process. Back pressure regulators are typically employed to hold pressure from downstream while allowing fluids to be pumped from upstream.

Under typical operating conditions, the internal components of back pressure regulators require regular maintenance. Back pressure regulators typically include multiple threadedly coupled sections and sealing surfaces. The sealing surfaces tend to wear out over time and result in leaks resulting in the need for regular maintenance, as well as general wear on components leading to a compromised pressure holding vessel. One cause of the wear is the speed of the flow of fluid in the back pressure regulator. Most back pressure regulators have standard thread connections for connecting to pipes at the inlet and the outlet of the back pressure regulator. Prior art back pressure regulators typically have a seat nipple that connects to an inlet pipe and a tee union that connects to an outlet pipe. Back pressure regulators are designed to connect to specific pipe sizes for the systems in which they are used. For example, a typical prior art back pressure regulator may have two-inch National Pipe Thread (“NPT”) threads to connect to a two-inch threaded pipe at the inlet and two-inch NPT threads to connect to a two-inch threaded pipe at the outlet. The tee union and seat nipple in such prior art back pressure regulators will have two-inch connection threads at all connection points. The flow of fluid through a prior art back pressure regulator can cause wear of the internal components that require frequent replacement, in some cases as little as 3-14 days.

### SUMMARY

In accordance with the present disclosure, an apparatus and method for reducing wear on the internal components of a back pressure regulator are provided. In one embodiment, a back pressure regulator is provided. The back pressure regulator comprises a regulator body and a seat nipple connected to the regulator body. The seat nipple is connected to an inlet pipe which communicates fluid to the regulator body through the seat nipple. The seat nipple is an expansion nipple that increases in size from a first inner diameter to a second larger inner diameter. The seat nipple will in one embodiment have an external inlet connecting thread at a first, or inlet end to connect to the inlet pipe. The inlet connecting thread on the seat nipple at the inlet end may be a standard thread, for example a standard NPT thread to connect to the inlet pipe. A second end of the seat nipple has an external thread sized to connect to a pipe that is larger than the inlet pipe. The second end of the seat nipple may be an NPT thread of a size to connect to a pipe that is, for example, a full size larger than the inlet pipe.

The back pressure regulator body may comprise a reducing tee that defines a flow outlet. The reducing tee has a rise portion and a run portion. The flow outlet is defined on the rise portion of the reducing tee. The flow outlet has an outlet connecting thread to connect to an outlet pipe. In one embodiment, the outlet connecting thread is sized to connect to an outlet pipe that is the same size as the inlet pipe. The outlet connecting thread at the flow outlet may be for example a standard NPT thread to connect to the outlet pipe. The rise portion of the tee has a thread to connect to the second end of the seat nipple. The rise portion of the reducing tee defines a rise inner diameter that is larger than a run inner diameter defined by the run portion of the reducing tee.

The back pressure regulator has a flow passage therethrough that will communicate fluid from the flow inlet to the flow outlet. A ball cage disposed in the regulator body defines part of the flow passage. A flow restrictor assembly is disposed in the regulator body and comprises a flow control member, a biasing member, which may be for example a spring, a sleeve defining a valve seat, and a sealing ball positioned to engage the valve seat. The sealing ball will engage the valve seat to prevent flow from the flow inlet to the flow outlet until a predetermined pressure is reached at the flow inlet. The flow control member may comprise an adjustment screw configured to adjust a compression force applied to the spring, thereby adjusting the predetermined pressure.

In one embodiment, the back pressure regulator disclosed herein has inlet and outlet connecting threads to connect to a standard size pipe used on existing crude oil processing systems. The rise portion of the tee is for connection to a second, larger standard sized pipe. As a result, the flow passage through the back pressure regulator has a diameter that is sized for a second, larger standard sized pipe. For example, the inlet and outlet connections may be for a two-inch NPT thread, while the rise portion of the tee is sized for use in a system that is designed for three-inch NPT pipe connections. Because the inner diameter of the seat nipple expands to connect to the reducing tee, the speed of the flow of fluid is reduced from that which would exist if the back pressure regulator included a standard tee as opposed to the reducing tee. The internal components of the back pressure regulator, including for example the valve seat and the sealing ball, will experience lower impact, and therefore less wear than with a standard back pressure regulator that does not use an expanding seat nipple and a reducing tee. The internal components will last longer, requiring less replacement time than with back pressure regulators that include a seat nipple and tee that do not provide the increased diameter flow path. In addition, the back pressure regulator disclosed herein can be used to connect to standard sized pipes in crude oil processing systems in which the back pressure regulator is used.

### BRIEF DESCRIPTION OF THE DRAWINGS

The drawings included with this application illustrate certain aspects of the embodiments described herein. However, the drawings should not be viewed as exclusive embodiments. The subject matter disclosed is capable of considerable modifications, alterations, combinations, and equivalents in form and function, as will occur to those skilled in the art with the benefit of this disclosure.

FIG. 1 is a side view of a back pressure regulator in accordance with one embodiment of the present disclosure.

FIG. 2 is a front view of a back pressure regulator in accordance with one embodiment of the present disclosure.

FIG. 3 is a cross section from line 4-4 of FIG. 2.

FIG. 4 is an exploded view of a back pressure regulator in accordance with one embodiment of the present disclosure.

### DETAILED DESCRIPTION

The present disclosure may be understood more readily by reference to these detailed descriptions. For simplicity and clarity of illustration, where appropriate, reference numerals may be repeated among the different figures to indicate corresponding or analogous elements. In addition, numerous specific details are set forth in order to provide a thorough understanding of the various embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts have been exaggerated to better illustrate details and features of the present disclosure.

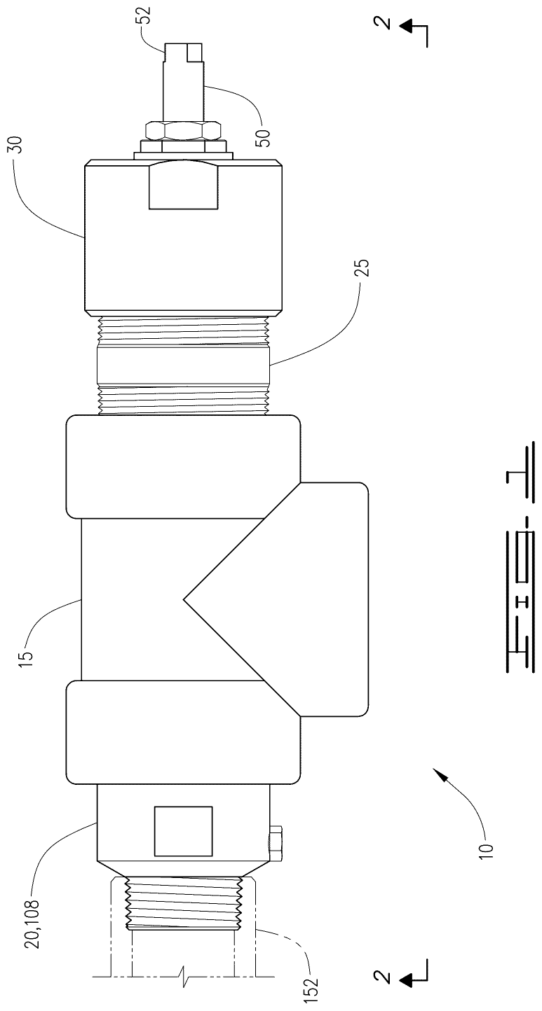

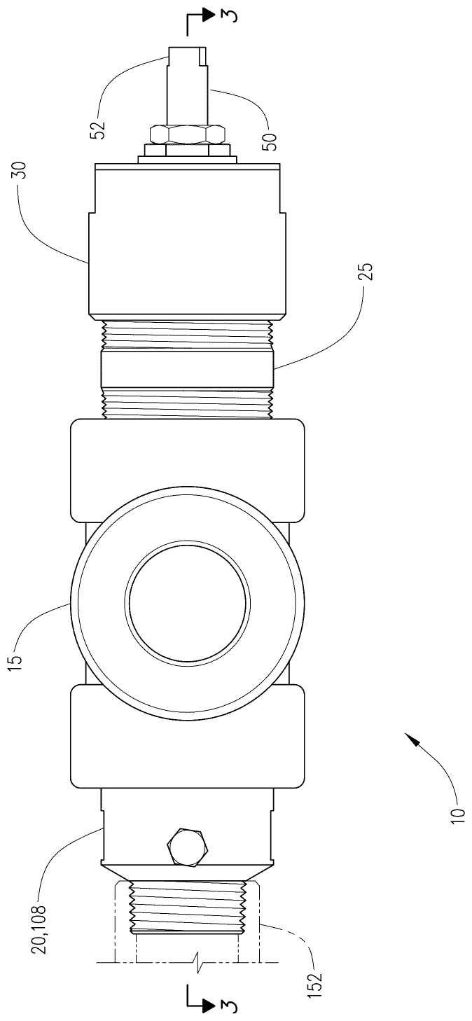

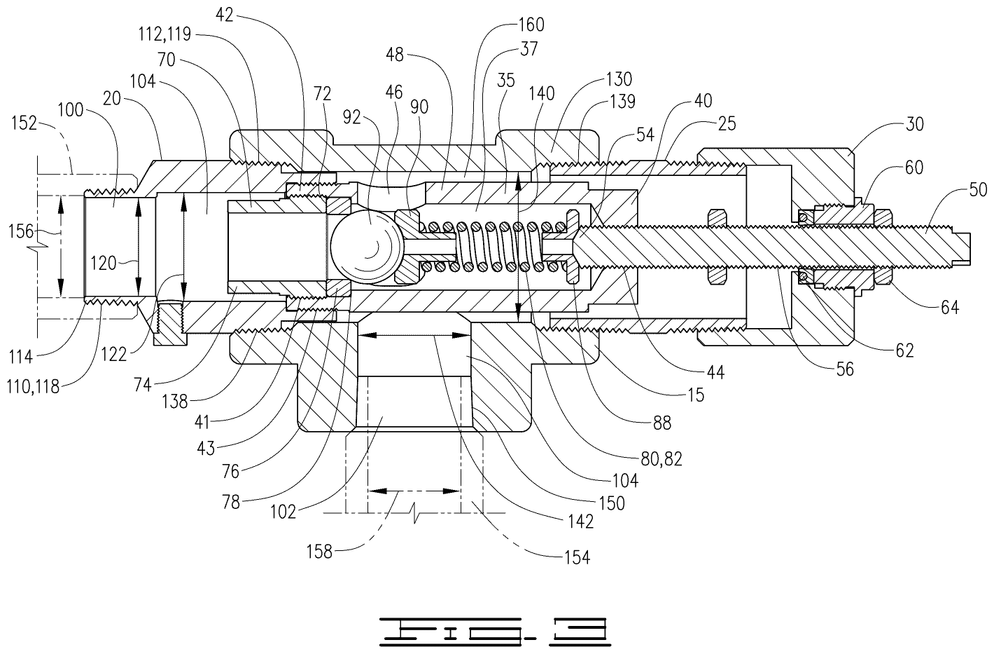

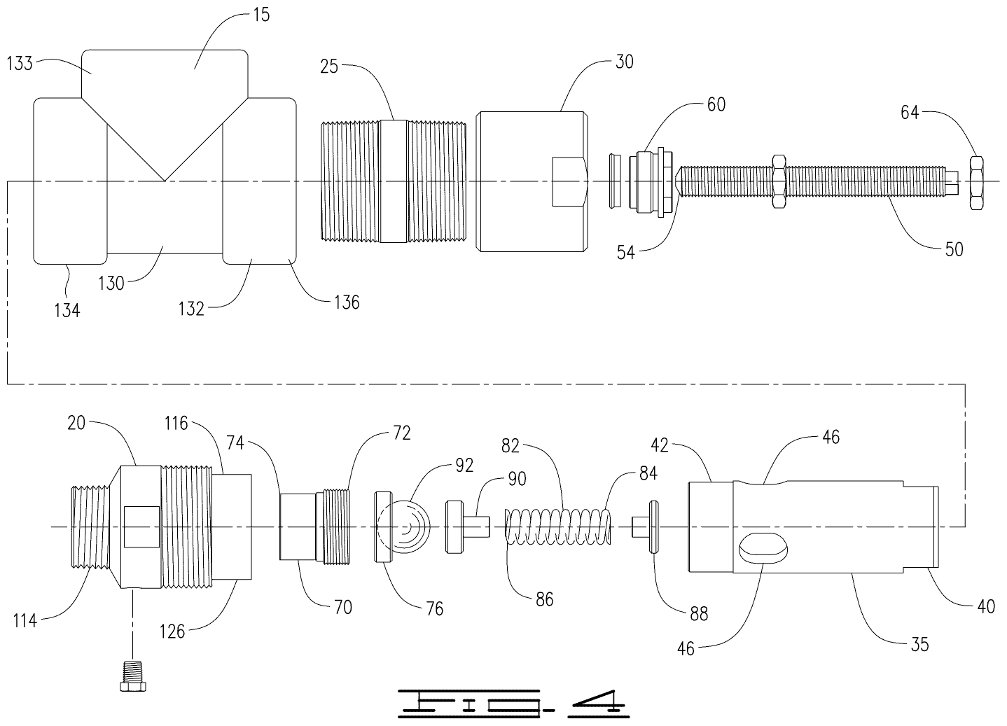

Referring now to FIGS. 1-4, the back pressure regulator of the current disclosure is illustrated and generally designated by the numeral 10. As shown by the drawings, the general form of back pressure regulator 10 includes regulator body 15 and a seat nipple 20 connected to regulator body 15. A connecting nipple 25 is connected to a cap 30 and to regulator body 15. A ball cage 35 is disposed in regulator body 15. Ball cage 35 has a ball cage interior 37 and has upper end 40 and lower end 42. Ball cage 35 has internal and external threads 41 and 43 at the lower end 42 thereof. External thread 43 is connected to seat nipple 20 as explained in more detail below. Ball cage 35 has a threaded opening 44 at the upper end 40 thereof and has a plurality of flow ports 46 in a wall 48. Adjustment screw 50 with upper end 52 and lower end 54 extends through cap 30 and into ball cage 35. Adjustment screw has threads 56 that thread into threaded opening 44 in ball cage 35. A packing nut 60 may be threaded into an opening in cap 30 with an O-ring seal 62 positioned in the opening. Adjustment screw 50 can move in the vertical direction in packing nut 60 as shown in the drawings. A jam nut 64 may be used at the upper end of packing nut 60 to stabilize adjustment screw 50.

A seat plug 70 with upper end 72 and lower end 74 is threadedly connected to internal thread 41 on ball cage 35. A valve seat 76 is positioned atop seat plug 70 and is held in place by a shoulder 78 defined on an inner surface of ball cage 35.

A flow restrictor assembly 80 is disposed in ball cage 35. Flow restrictor assembly 80 comprises a spring 82 with upper and lower ends 84 and 86. Upper and lower spring keepers 88 and 90 extend into the upper and lower ends 84 and 86 of spring 82. A sealing ball 92 is engaged with valve seat 76. Adjustment screw 50 is a flow control member that engages upper spring keeper 88 and applies a downward force thereto. Spring 82 acts as a biasing element and urges sealing ball 92 downward into valve seat 76. The force applied by spring 82 will be such that no flow is allowed through the back pressure regulator 10 until a predetermined pressure is reached at the inlet. The pressure through the back pressure regulator 10 is thus regulated with the flow restrictor assembly 80.

Back pressure regulator 10 has a flow inlet 100, a flow outlet 102 and a fluid passageway 104 from flow inlet 100 to flow outlet 102. Flow inlet 100 is defined by seat nipple 20 which in the embodiment described is an expanding seat nipple 108 (also referred to herein as “expansion nipple 108”). Expansion nipple 108 expands from a first size pipe connection 110 to a second size pipe connection 112. First and second pipe size connections 110 and 112 are in one embodiment standard pipe connections. For example, seat nipple 20 may be an expansion nipple 108 that expands one full pipe size. Expansion nipple 108 has a first end 114 and second end 116. First size pipe connection 110 at first end 114 is an external thread 118. Second size pipe connection 112 at second end 116 is an external thread 119. External thread 118 may be referred to as an inlet connecting thread 118. External thread 119 is for connection to a larger pipe than the inlet connecting thread 118. Inlet connecting thread 118 will connect to a first, or inlet pipe 152. External threads 118 and 119 are in one embodiment standard threads and may be for example standard NPT threads. Standard simply means that it is of a size/configuration that is generally available (e.g., one-inch, two-inch, three-inch etc.). Expansion nipple 108 has a first inner diameter 120 and a second inner diameter 122 that is larger than the first inner diameter 120. A flange 126 extends upwardly on expansion nipple 108 and threadedly connects to ball cage 35.

Regulator body 15 may comprise a reducing tee 130 with rise 132 and run 133. Rise 132 has first and second ends 134 and 136 with threads 138 and 139. In the described embodiment, threads 138 and 139 are internal threads which may be NPT threads. Threads 138 are sized to connect to external thread 119 on second end 116 of expansion nipple 108. Threads 139 connect regulator body 15 to connecting nipple 25. Rise 132 defines an inner diameter 140 and run 133 defines a smaller inner diameter 142. Flow outlet 102 is defined on run 133. An outlet connecting thread 150 is defined at flow outlet 102 on run 133. Reducing tee 130 reduces from one pipe size to a second smaller pipe size. In the described embodiment, reducing tee 130 reduces so that outlet connecting thread 150 that will connect to a pipe 154 that is the same size as pipe 152 that connects to expansion nipple 108 at inlet connecting thread 118. Because pipes 152 and 154 are the same size, the inner, or flow diameters 156 and 158 of pipes 152 and 154 are substantially the same.

In operation, fluid will flow through inlet pipe 152. High pressure fluid enters back pressure regulator 10 through flow inlet 100. Back pressure regulator 10 will not allow fluid to flow therethrough from flow inlet 100 to flow outlet 102 above a certain, predetermined pressure. For example, if the components downstream from back pressure regulator 10 are designed for pressures of 1000 psi or less, and the pressure in the well is 1500 psi, back pressure regulator 10 will restrict flow such that the flow through flow outlet 102 is limited to 1000 psi. Fluid will pass through flow passage 104 and will not allow flow downstream above a predetermined pressure. The force applied to sealing ball 92 is adjustable with flow control member 50. Fluid passageway 104 comprises the path defined by the opening in expansion nipple 108, seat plug 70 and valve seat 76. Fluid passageway 104 further comprises flow ports 46 in ball cage 35, an annulus 160 defined between ball cage 35 and a wall of reducing tee 130, and the opening defined by inner diameter 142 of run 133.

The high-pressure fluid to which the back pressure regulator 10 is exposed can wear down the internal components thereof. In particular, the fluid can generate wear to the valve seat 76 and sealing ball 92 which when worn require replacement. In the described embodiment, the velocity of the high-pressure fluid slows after entering expansion nipple 108 as a result of the increase in size from first inner diameter 120 to second inner diameter 122 in expansion nipple 108. The velocity of the flow may decrease by as much as, for example forty (40) percent. In one embodiment, back pressure regulator 10 has inlet and outlet connecting threads 118 and 150 for connecting to first standard size NPT thread, while the second end of the expansion nipple tee 108 is configured for a connection to a second larger size NPT thread. For example, the inlet and outlet connecting threads 118 and 150 at the flow inlet and outlet 100 and 102 may be configured to connect to a standard 2-inch NPT thread, while the first and second ends of the run portion of the reducing tee 130 is a 3-inch NPT connection. The back pressure regulator 10 is therefore configured to connect to pipes for a first size back pressure regulator 10, but the internal components are sized for a second, larger size back pressure regulator 10. Thus, back pressure regulator inlet and outlet threaded connections 118 and 150 may be for example for a 2-inch pipe, while at least the seat plug 70, valve seat 76, sealing ball 92 and other internal components are for a standard 3-inch back pressure regulator 10.

In some embodiments, regulator body 15 and cap 30 are at least partially formed of, but not limited to, alloy steel. In additional embodiments, each individual component of back pressure regulator 10 is at least partially formed, but not limited to, alloy steel, stainless steel, or other iron byproducts known by those of ordinary skill in the art.

Therefore, the present disclosure is well adapted to attain the ends and advantages mentioned, as well as those that are inherent therein. The embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered or modified, and all such variations are considered within the scope and spirit of the present disclosure. While apparatus and methods may be described in terms of “comprising,” “containing,” “having,” or “including” various components or steps, the apparatus and methods can also, in some examples, “consist essentially of” or “consist of” the various components and steps. Also, the terms in the claims have their plain, ordinary meaning unless otherwise explicitly and clearly defined by the specification.

What is claimed:

1. A back pressure regulator comprising:
an expanding nipple defining a fluid passageway having a first inner diameter and a second inner diameter larger than the first inner diameter, the expanding nipple having an inlet connecting thread at a flow inlet for connecting to an inlet pipe and a second threaded end for connecting to a larger pipe;
a reducing tee having a rise and a run, the run defining a run inner diameter larger than a rise inner diameter, the run having a first threaded end sized to connect to the second threaded end of the expanding nipple, and the rise end defining a flow outlet having an outlet connecting thread to threadedly connect to an outlet pipe of the same size as the inlet pipe;
a cap coupled to the reducing tee; and
a flow restrictor assembly disposed in the reducing tee to restrict flow therethrough.

2. The back pressure regulator of claim 1, further comprising:
a connecting member coupling the reducing tee to the cap, a second threaded end of the run sized identically to the first threaded end of the run.

3. The back pressure regulator of claim 1, the inlet connecting thread comprising a standard male NPT thread for connecting to the inlet pipe, the outlet connecting thread comprising a standard female NPT thread for connecting to the outlet pipe.

4. The back pressure regulator of claim 3, wherein the inlet connecting thread is a standard size for connecting to a first standard full size pipe, and wherein the second threaded end of the seat nipple is a larger standard size for connecting to a second standard full size pipe.

5. The back pressure valve of claim 4, the inlet connecting thread comprising a two-inch NPT and the second threaded end comprising a three-inch NPT.

6. The back pressure valve of claim 1, wherein the flow restrictor comprises:
a sleeve disposed in the run of the reducing tee, the sleeve defining a valve seat;
a sealing ball positioned in the run and engageable with the valve seat; and
a biasing element engaging the sealing ball to urge the sealing ball against the seat to prevent flow to the flow outlet until a predetermined pressure is reached.

7. The back pressure regulator of claim 1, wherein a flow velocity of a fluid flowing into the back pressure regulator is decreased after it passes through the first diameter of the expanding nipple.

8. The back pressure valve of claim 7, wherein the flow velocity decreases by at least 40%.

9. A back pressure regulator comprising:
a flow inlet;
an inlet pipe threaded to the first flow inlet, the first pipe having a first flow diameter;
a flow outlet;
an outlet pipe threadedly connected to the flow outlet, the outlet pipe having a second flow diameter substantially the same as the first flow diameter;
a flow passage from the flow inlet to the flow outlet;
the flow inlet defined on an expansion seat nipple connected to the inlet pipe; and
a flow restrictor assembly positioned in the flow passage to prevent flow from the flow inlet to the flow outlet until a predetermined pressure is reached.

10. The back pressure regulator of claim 9, the flow outlet being defined on a reducing tee.

11. The back pressure regulator of claim 10, the expansion seat nipple comprising a two-inch by three-inch expanding nipple, and the reducing tee comprising a three-inch by two-inch reducing tee.

12. The back pressure regulator of claim 9, the flow restrictor comprising:
a valve sleeve defining a ball seat;
a sealing ball engaged with the ball seat; and
a biasing element engaged with the sealing ball urging the sealing ball in a direction toward the ball seat.

13. The back pressure regulator of claim 12, wherein the valve sleeve is sized for a back pressure regulator one full size larger than a back pressure regulator sized for the inlet and outlet pipes.

14. The back pressure regulator of claim 9, wherein the velocity of the fluid decreases from a first velocity in a first inner diameter of the expanding nipple to a second velocity in the second inner diameter of the expanding nipple.

15. The back pressure regulator of claim 14, wherein the velocity decreases by at least 40%.

16. A back pressure regulator comprising:
an expanding nipple defining a flow inlet;
a reducing tee defining a flow outlet; and
a flow restrictor disposed in the reducing tee between the flow inlet and the flow outlet to restrict flow from the flow inlet to the flow outlet to a maximum predetermined pressure.

17. The back pressure regulator of claim 16, the expansion seat nipple expanding from a first full size standard NPT thread to a second full size standard NPT thread, and the reducing tee reducing from the second full size standard NPT thread to the first full standard size NPT thread.

18. The back pressure regulator of claim 17, the expansion seat nipple comprising a three-inch by two-inch expanding nipple and the reducing tee comprising a three-inch by two-inch reducing tee.
